(19) United States
(12) Patent Application Publication
(10) Pub. No.: US 2003/0003284 A1
(43) Pub. Date: Jan. 2, 2003

(54) MULTILAYER COMPOSITE MATERIALS WITH AT LEAST ONE AEROGEL-CONTAINING LAYER AND AT LEAST ONE LAYER CONTAINING POLYETHYLENE TEREPHTHALATE FIBRES, PROCESS FOR PRODUCING THE SAME AND THEIR USE

(76) Inventors: FRITZ SCHWERTFEGER, FRANKFURT (DE); MARC SCHMID, FRANKFURT (DE); DIERK FRANK, HOFHEIM (DE)

Correspondence Address: FROMMER LAWRENCE & HAUG, 745 FIFTH AVENUE- 10TH FL., NEW YORK, NY, 10151, US

(21) Appl. No.: 09/355,046

(22) PCT Filed: Jan. 22, 1998
(86) PCT No.: PCT/EP98/00330

(30) Foreign Application Priority Data
Jan. 24, 1997 (DE) 197 02 239.1

(51) Int. Cl. B32B 27/04; B32B 27/12; D04H 13/00

(52) U.S. Cl. 428/292.1; 428/297.4; 428/300.7

(57) ABSTRACT

Multilayer composite materials with at least one aerogel-containing layer and at least one layer containing polyethylene terephthalate fibres, process for producing the same and their use.

### DESCRIPTION

The invention relates to novel multilayer composite materials of any conformation, having very high heat-insulating and/or body and tread acoustic-insulating ability, processes for production thereof, and their use.

Conventional heat-insulating or body and tread acoustic-insulating materials based on polystyrenes, polyolefines and polyurethanes are produced using propellants such as for example FC hydrocarbons, CO₂ or pentane. The propellant enclosed in the cells of the foam is responsible for the high insulating ability. However, such propellants are a burden on the environment, since they slowly escape into the atmosphere.

Aerogels in the broad sense, i.e. in the sense of ‘gel with air as dispersion agent,’ are produced by drying a suitable gel. The term “aerogel” in this sense includes aerogels in the narrow sense, xerogels and cryogels. Thus a dried gel is referred to as an aerogel in the narrow sense if the liquid of the gel is very largely removed at temperatures above the critical temperature and starting out from pressures above the critical pressure. But if the liquid of the gel is removed subcritically, for example with formation of a liquid-vapor boundary phase, then the resulting gel may often be referred to as a xerogel. When the term aerogels is used in the present application, it refers to aerogels in the broader sense, i.e. in the sense of ‘gel with air as dispersion agent.’

Various processes for producing aerogels by super- or subcritical drying are disclosed for example in EP A 0,396,076, WO 92/03378, WO 94/25149, WO 92/20623 and EP A 0,658,513.

The aerogels obtained by supercritical drying are generally hydrophile or only briefly hydrophobe, whereas aerogels dried subcritically, by virtue of their production (generally silylation before drying) are permanently hydrophobe.

Furthermore, aerogels may in principle be subdivided into inorganic and organic aerogels, inorganic aerogels having been known ever since 1931 (S. S. Kistler, Nature 1931, 127, 741), whereas organic aerogels from a wide variety of starting materials, e.g. melamine formaldehyde, have been known for only a few years (R. W. Pekala, J. Mater. Sci. 1989, 24, 3221).

Besides, composite materials containing aerogels may in principle be subdivided into opaque and transparent/translucent composite materials. They are used as heat insulators chiefly by reason of their low heat conductivity.

Opaque composite materials containing aerogels are disclosed for example in EP A 0,340,707, EP A 0,667,370, WO 96/12683, WO 96/15997 and WO 96/15998. These composite materials in some instances do contain transparent aerogel granulates, but the additional components are opaque, rendering the systems opaque as a whole.

Transparent composite materials containing aerogels are described in German Patent Application P 196 34 109.4. Here aerogel particles are bonded together into moldings of any shape by means of transparent and/or translucent plastics as binder.

Again, a transparent aerogel composite is disclosed in DE A 4,430,642 and DE A 4,430,669. Such a composite material is present for example in the form of a mat containing the aerogels and fibers distributed therein, the aerogel fragments being held together by the fibers. While good results have been obtained with such transparent materials, disadvantages of cost remain, besides the need to produce the systems in one step.

A transparent component having at least two sheets of transparent material in parallel arrangement, with fiber-reinforced aerogel plates and mats in the space between, is disclosed for example in German Patent Application 195 07 732.6. By this measure, the stability of the system is much enhanced, but complicated structure and high cost remain.

An alternative to the composite materials containing aerogel is described in CA C 1,288,313, EP A 018,955 and DE A 4,106,192. According to these sources, aerogel monoliths are placed between sheets of glass to improve insulating effect through the low heat conductivity of the aerogel and/or to improve the acoustic attenuation of such sheets. In this way, while nearly glass-clear, transparent sheets can be obtained, yet owing to the low mechanical stability of the aerogels, the outlay for production of suitably large monoliths is too high for such glass sheets to be used on a larger scale.

Also, aerogel-filled “vacuum panel” systems are known, as disclosed for example in EP A 0,468,124, EP A 0,114,687 and DE A 3,347,619. The disadvantage of the “vacuum panel” systems, however, is that they cannot be altered in shape or size subsequently at the point of use.

The composite materials containing aerogel and known to the literature as described above do have a low heat conductivity, but the proportion of aerogel particles must be very high to achieve heat conductivities under 50 mW/mK. Hence such systems are very susceptible to mechanical load, greatly restricting their serviceability. Besides, owing to the high costs involved in the aerogel, they are very expensive. Furthermore, the surfaces of such composite materials and their properties are to a very large extent determined by the aerogel, since this is distributed more or less uniformly throughout the system. Hence these composite materials must often be clad for easy processing with other components in the field of application in question. However, this will usually entail additional steps in manufacture.

One object of the present invention, then, was to develop a heat-insulating composite material containing aerogels, simple to produce, in any shape and size, and not exhibiting the above mentioned disadvantages of the systems known in the prior art.

Besides, it was an object of the present invention to develop a composite material containing aerogels, having better heat insulation for like proportions of aerogel, i.e. lower heat conductivity, or a comparable heat insulation with a smaller proportion of aerogel than conventional composite systems.

Still another object of the present invention was to prepare a heat-insulating composite material containing aerogels and moreover having body and/or tread acoustic-insulating properties.

Within the scope of this specification, body sound is understood to mean sound propagated in solids. By tread sound is meant the sounds resulting for example from walking on a ceiling or moving chairs, and emitted partly as body sound and partly as air sound (company brochure, Rhinolith Dämmstoffe GmbH; specifications in 150 Bauphysik 6/96 and W. Reichgraf, Grundlagen der technischen Akustik, Akademische Verlagsgesellschaft, Leipzig 1968).

The objects described above are accomplished by a multilayer composite material comprising at least one layer containing aerogel and at least one layer containing polyethyleneterephthalate fibers.

The multilayer composite material according to the invention thus comprises at least two, preferably at least three, layers.

Especially preferred is a composite material having three layers, and in particular a “sandwich” system, in which a layer containing aerogel is arranged between two layers each containing polyethyleneterephthalate fibers.

The proportion of aerogel particles in the at least one layer containing aerogel should generally lie in the range from 5 to 97 vol. %.

With an aerogel particle content significantly below 5 vol. % in the at least one layer containing aerogel, owing to the low content of aerogel particles in the composite material, its positive properties would be lost to a large extent. Such a composite material would fail to exhibit low densities and heat conductivities.

An aerogel particle content significantly above 97 vol. % would lead to a polyethyleneterephthalate fiber and optionally binder content of less than 3 vol. %. In that case, this proportion would be too low to ensure an adequate connection of the aerogel particles with each other, as well as mechanical compressive and beiding strengths.

In the at least one layer containing aerogel, the proportion of aerogel particles preferably lies in the range from 40 to 95 vol. %, especially so in the range from 60 to 95 vol. %.

An especially high proportion of aerogel particles in the at least one aerogel-containing layer of the composite material may be achieved by using a bimodal distribution of grain sizes. Another possibility for achieving an especially high proportion of aerogel particles in the at least one aerogel-containing layer of the composite material is the use of aerogel particles exhibiting a logarithmic normal distribution of grain size.

In order moreover to achieve as high a fill factor as possible, it is advantageous also if the aerogel particles are small compared to the total thickness of the aerogel-containing layer.

The size of the aerogel particles in the at least one aerogel-containing layer of the composite material lies preferably in the range from 250 microns to 10 mm, especially so in the range from 250 microns to 5 mm, and most especially so in the range from 250 microns to 2 mm. The size of the aerogel particles here refers only to the mean diameter of the individual aerogel particle, while the aerogel particles, for reasons of production, for example by grinding, need not necessarily be of substantially spherical shape.

Aerogels generally used for the composite materials according to the invention are those based on metal oxides, suitable for the “sol-gel” technology (C. J. Brinker, G. W. Scherer, Sol-Gel-Science 1990, ch. 2 and 3), such as for example Si or Al compounds, or those based on organic substances suitable for the “sol-gel” technology, such as for example melamine formaldehyde condensates (U.S. Pat. No. 5,086,085) or resorcinol formaldehyde condensates (U.S. Pat. No. 4,873,218). The compound materials may alternatively be based on mixtures of the materials mentioned above. Preferably, use is made of aerogels containing Si compounds, and particularly SiO₂ aerogels.

To reduce the radiation component of the heat conductivity, the aerogel may contain IR turbidity agents, such as for example carbon black, titanium dioxide, iron oxides or zirconium dioxide and mixtures thereof.

In a preferred embodiment, the aerogel particles permanently comprise hydrophobe surface groups. Examples of suitable groups for lasting hydrophobization are silyl groups of general formula —Si(R)ₙ, where n=1, 2 or 3, preferably trisubstituted silyl groups in which the radicals are, in general independently of each other, alike or different, each R a hydrogen atom or a non-reactive organic linear, branched, cyclic, aromatic or hetero-aromatic radical, preferably C₁-C₁₈ alky or C₆-C₁₄ aryl, especially so C₁-C₆ alkyl, cyclohexyl or phenyl, in particular methyl or ethyl. Especially advantageous for lasting hydrophobization of the aerogel is the use of trimethylsilyl groups. The introduction of these groups may be accomplished for example as described in WO 94/25149 or German Patent Application P 196 48 793.6, or by gaseous phase reaction between the aerogel and for example an activated trialkylsilane derivative such as for example a chlorotrialkylsilane or a hexalkyldisilazane (cf. R?ller, The Chemistry of Silica, Wiley & Sons 1979). Compared to OH groups, the hydrophobe surface groups thus produced also diminish the dielectric loss factor and the dielectric constant.

Aerogel particles with hydrophile surfaces, depending on atmospheric humidity, can adsorb water, with the result that the dielectric constant and the dielectric loss factor may vary with the relative humidity. This is often undesirable for electronic applications. The use of aerogel particles with hydrophobe surface groups prevents such variation, since no water is adsorbed. The selection of the radicals will also depend on the typical service temperature.

If aerogel particles with hydrophobe surfaces are used in combination with hydrophobe polyethyleneterephthalate fibers and optionally hydrophobe binders, a hydrophobe composite material is obtained.

Furthermore, the thermal conductivity of the aerogels decreases with increasing porosity and decreasing density. Preference is therefore given to aerogels having porosities over 60% and densities below 0.6 g/cm³. Especially preferred are aerogels with densities below 0.2 g/cm³, and most especially, aerogels with densities between 0.16 and 0.10 g/cm³.

In a special embodiment, the at least one layer containing PET fibers may in addition also contain aerogel particles, the proportion here lying preferably in the range from 0 to 40 vol. % and the same aerogels being eligible as for the at least one aerogel-containing layer.

In another embodiment, the at least one aerogel-containing layer and/or the at least one layer containing PET fibers may additionally contain at least one binder.

This binder forms a matrix that connects or encloses the aerogel particles and/or the PET fibers and may extend as a continuous phase throughout the composite material, preferably at least through the at least one aerogel-containing layer.

As binders for the composite materials according to the invention, generally dispersion adhesives are employed, as for example Mowilith®, or polyvinylbutyral, as for example Mowital®.

In the several layers, the binder is generally employed in a quantity of from 3 to 95 vol. %, preferably in a quantity of from 3 to 60 vol. %, more so in a quantity of from 3 to 40 vol. %, and especially so in a quantity of from 3 to 20 vol. %.

Further, the at least one aerogel-containing layer of the composite material may also contain up to 50 vol. % fillers, as for example wood meal, asbestos and preferably cellulose, for example to improve the mechanical properties. Preferably the proportion of fillers lies in the range from 0 to 20 vol. %.

As polyethyleneterephthalate (PET) fibers, use may be made of PET homopolymers, PET copolymers, PET “compounds,” PET recyclate and other PET varieties, recyclate being preferred.

The PET fibers may alternatively be coated, for example metalized with a metal such as aluminum.

The fibers may be smooth or crimped as individual fibers, as a bunch, or as fiber fabrics, woven or unwoven. Woven or unwoven fiber fabrics may be contained in the composite material as a connected whole and/or in the form of several small pieces.

The fibers may be round, trilobal, pentalobal, octalobal, strip-shaped, pinetree-shaped, dumbbell-shaped or otherwise star-shaped in profile. Hollow fibers may likewise be used.

In general, fibers between 0.1 micron and 5 mm in diameter are employed. Typically, for given proportion of fibers by volume, the use of smaller diameters leads to less fragile composite materials. By choice of very thin fibers, the composite material is rendered more flexible. Therefore fiber diameters in the range from 0.1 to 30 microns are preferred.

The length of the fibers is not subject to any limitation whatever. By the length and the distribution of the fibers in the composite material, however, its mechanical strength may be influenced. Therefore, use is preferably made of fibers between 0.5 and 10 cm in length.

Also, mixtures of the types mentioned above may be used.

Further, the heat conductivity of the fiber material should preferably be less than 1 W/mK.

By suitable choice of fiber diameter and/or materials, the radiant contribution to the thermal conductivity can be reduced and a greater mechanical strength achieved.

The radiant contribution to the thermal conductivity may be further reduced by using PET fibers blackened with carbon black for example.

The fibers may also be coated with layers or with contact intermediaries (“coupling agents”) for better binding to the matrix.

It is advantageous further if the at least one layer containing PET fibers also contains portions of air, that is to say, is not completely compressed, since the combination of the heat conductivities of fibers and air yields a lower heat conductivity.

The at least one aerogel-containing layer may also additionally contain PET fibers, the same fibers being eligible as PET fiber material as for the at least one layer containing PET fibers. The addition of fibers is advantageous especially for thermal applications and in terms of crack formation and ultimate strength.

The diameter of the fibers used in the at least one aerogel-containing layer should preferably be smaller than the mean diameter of the aerogel particles, to make possible a high proportion of aerogel in this layer. The length of the fibers in the at least one aerogel-containing layer should preferably be greater than the mean diameter of the aerogel particles.

The stability as well as the thermal conductivity of the at least one aerogel-containing layer of the composite material increases with increasing proportion of fibers. To avoid a significant increase of heat conductivity due to the added fibers in this at least one layer, the volume proportion of fibers should preferably be between 0.1 and 40 vol. %, especially so in the range between 0.1 and 15 vol. %.

Compared to a layer consisting only of aerogel particles connected by way of their surfaces or incorporated in a binder matrix, even small volume proportions of fibers, surprisingly enough, lead to a substantial mechanical reinforcement for given volume proportion of binders, because they assume substantial portions of the load. If a higher volume proportion of fibers is used, and but little binder, a porous layer may be obtained, in which the fibers connected by the binders form a mechanically stable framework in which the aerogel particles are lodged. The air pores that then occur lead to a higher porosity and hence to improved acoustic insulation.

By the binder, either the fibers and/or the aerogels are connected among and optionally with each other, or else the binder serves as matrix material in which the fibers and/or the aerogel particles are imbedded.

Further, in the at least one aerogel-containing layer of the composite material, lubricants may also be present in small amounts, as for example zinc stearate, pigments as for example titanium dioxide, plasticizers such as for example glycerine and o,p-toluenesulfonamide and/or acid or acid-yielding setting accelerators.

Besides, also so-called “coupling agents” may be employed. They effect a better contact of the binder with the surface of the aerogel particles and may moreover enter into a firm bond both with the aerogel particles and with the binder.

If the material is employed in the form of areal configurations, as for example plates or mats, it may be clad on at least one side with at least one covering layer to improve the properties of the surface, as for example to enhance “robust”-ness, form a vapor barrier, or protect it from readily soiling. The covering layers may also improve the mechanical stability of the molded composite material. If covering layers are used on both surfaces, they may be alike or different. The thickness of the covering layer(s) should generally be less than 100 microns.

As covering layers, all materials known to those skilled in the art are suitable. They may be non-porous and so act as a vapor barrier, as for example plastic films, preferably metal foils or metalized plastic films reflecting heat radiation. Alternatively, however, porous covering layers may be used, permitting penetration of air into the material and thus leading to better acoustic insulation, as for example porous films, papers, woven or unwoven fabrics.

The covering layers may themselves consist of several layers. The covering layers may be attached with binders, connecting the fibers and the aerogel particles among themselves and with each other; alternatively, some other adhesive may be employed.

Further, the mechanical strength of the multilayer composite material according to the invention may be improved by laminating on of screen fabrics or films to the plate surface. The screen fabrics or films may be applied either subsequently or else during production of the composite material. The latter is preferred, and may for example be done in one operation by laying the screen fabrics or films in the mold over the aerogel-containing compound to be pressed, and then molding under pressure and temperature to make an aerogel-containing composite panel.

The thickness of the at least one layer containing PET is generally more than 100 microns, preferably at least 500 microns, and in particular at least 1 mm. Nevertheless, these layers should be thin, especially compared to the at least one aerogel-containing layer, so that the over-all heat conductivity of the composite material will be as low as possible. To reduce the radiation component of heat conductivity, the composite material may contain IR turbidity agents, as for example carbon black, titanium dioxide, iron oxides or zirconium dioxide as well as mixtures thereof, as is advantageous especially for high-temperature applications.

Should the composite material, owing to the polyethyleneterephthalate fibers or the binders used and/or owing to hydrophile aerogel particles, become hydrophile, optionally a subsequent treatment may be carried out that imparts hydrophobe properties to the composite material. All substances known to those skilled in the art for this purpose that will lend a hydrophobe surface to the composite material are suitable, as for example lacquers, films, silylation agents, silicone resins, as well as inorganic and/or organic binders.

The multilayer composite materials according to the invention preferably have a density of less than 0.6 g/cm³ and preferably a heat conductivity of less than 100 mW/mK. More preferably, the heat conductivity is below 50 mW/mK, especially in the range from 15 to 40 mW/mK.

The fire rating of the composite material obtained after drying is determined by the fire rating of the aerogel and/ or of the other constituents. To obtain as favorable a fire rating of the composite material as possible (not readily flammable or incombustible), preferably use is made of materials that are not readily flammable. Besides, in order to achieve as favorable a fire rating as possible, use may be made of any materials and methods known to those skilled in the art (as for example fire-retarding paints, varnishes, films and claddings).

To produce the composite materials according to the invention as multilayer systems, any methods and processes known to those skilled in the art may be employed.

Preferably the at least one aerogel-containing and the at least one layer containing PET fibers are either produced simultaneously and connected to each other in one step, or else produced separately and then connected to each other. This connecting may be done by means of at least one separate binder or by means of the binders employed in the at least one aerogel-containing or the at least one PET fiber-containing layer.

In the at least one aerogel-containing layer, the aerogel particles may be connected to each other by means of at least one binder. This connection of the individual particles to each other may be made quasi-pointwise. Such a superficial coating may for example be achieved by spraying the aerogel particles with the binder. The coated particles are then for example placed in a mold and allowed to set.

In a preferred embodiment, additionally the interstitial volume between the individual particles is filled out with binder in whole or in part. Such a composition may for example be produced by mixing the aerogel particles and optionally the fibers with the binder.

This mixing may be done in any conceivable manner. Thus it is possible firstly to place the at least two components in the mixing device simultaneously, and secondly one of the components may be taken first and the other(s) then added.

The mixing device required for the mixing is likewise not limited in any way whatever. Any mixing device known to those skilled in the art for this purpose may be used.

The mixing operation is carried out until an approximately uniform distribution of the aerogel particles in the composition is present. This mixing operation may be regulated either through the duration or for example through the speed of the mixing device.

Then follows the molding and setting of the mixture in the mold, using dispersion adhesives, by heating and/or evaporating the dispersion agent used, or, using polyvinylbutyrals, by cooling below the melting temperature of the binder.

In a preferred embodiment, the mixture is pressed. Here those skilled in the art can select the suitable press and the suitable tool for the particular application. Owing to the high proportion of air in the aerogel-containing composite material, the use of vacuum presses is advantageous. In a preferred embodiment, the aerogel-containing composite materials are pressed into panels. Here the at least one layer containing PET fiber can be pressed directly at the same time.

To prevent the compound from sticking to the die, the mixture to be pressed may be separated from the die with parting paper. The mechanical strength of the composite materials may be improved by laminating on screen fabrics, mats or papers to the surface. The screen fabrics, mats or papers may be either applied to the panels subsequently, in which case the screen fabrics, mats or papers may be previously impregnated with melamine resins and then connected to the panel surfaces under pressure in a heatable press, or else, in a preferred embodiment, in one operation, by placing the screen fabrics, mats or papers, which may be previously impregnated with melamine resin, in the mold and placing it on the compound to be pressed, and then pressing it into a composite panel under pressure and temperature.

The pressing, depending on the binder used, is generally done at pressures from 1 to 1000 bars and temperatures from 0 to 300° C., in any molds.

The layers containing PET fibers may be produced analogously to the aerogel-containing layers.

In the case of composite materials containing an especially high volume proportion of aerogel particles, and having a correspondingly poor heat conductivity, heat may additionally be introduced into the panels with the aid of suitable radiation sources. If, as for example in the case of polyvinylbutyrals, the binder used will couple with microwaves, that source of radiation is preferred.

The composite materials according to the invention, after setting, are suitable as heat insulators, because of their low heat conductivity.

Further, the composite materials are suitable as acoustic insulators, preferably for damping body and tread sounds.

The invention will be described below in more detail in terms of embodiments by way of example, without being limited thereby.

The hydrophobe aerogels were prepared analogously to the process disclosed in DE A 4,342,548.

The heat conductivities of the aerogel granulates were measured by a hot-wire method (see e.g. B. O. Nielsson, G. Rüschenpöhler, J. Gross, J. Fricke, High Temperature-High Pressures 21, 267-274 (1989)).

The heat conductivities of the molded objects were measured according to DIN 52612.

As a measure of the improvement in body and tread acoustic insulation, the tread sound improvement index of DIN 52210 was determined.

### EXAMPLE 1

Molded Object—Aerogel, Polyvinylbutyral, and PET “Recycling” Fibers

80 vol. % hydrophobe aerogel granulate and 20 vol. % powdered polyvinylbutyral Mowital® (Polymer F) are intimately mixed. The hydrophobe aerogel granulate has a grain size under 500 microns, a bulk density of 75 kg/m³, a BET surface area of 640 m²/g and a heat conductivity of 11 mW/mK.

The bottom and the cover of the mold, base area 30×30 cm, is lined with parting paper. On the bottom, enough coarsely opened PET fiber remnants in the form of “recycling” fibers is distributed (mixed with 2 wt. % polyvinylbutyral powder) so that the ensuing pressing operation forms a layer of PET fiber remnants 2 mm in thickness. Then the aerogel-containing composition is evenly distributed, and once more enough coarsely opened PET fiber remnants are distributed as recycling fibers (mixed with 2 wt. % polyvinylbutyral powder) is placed thereon so that after pressing, a layer of PET fiber remnants 2 mm in thickness will have formed on top as well. Then it is pressed to a thickness of 9 mm at 220° C. for 30 minutes.

The molded object obtained has a density of 250 kg/m³ and a heat conductivity of 45 mW/mK. The tread acoustic improvement factor is 16 dB.

### Comparative Example 1

Molded Object—Aerogel, Polyvinylbutyral, and PET “Recycling” Fibers

50 vol. % hydrophobe aerogel granulate, 10 vol. % polyvinylbutyral powder Mowital® (Polymer F) and 40 vol. % PET fibers are intimately mixed.

The bottom and cover of the mold, space area 30×30 cm, are lined with parting paper. Then the aerogel-containing composition is evenly distributed thereon. This is pressed to a thickness of 9 mm at 220° C. for 30 minutes.

The molded object obtained has a density of 255 kg/m³ and a heat conductivity of 50 mW/mK. The tread acoustic improvement factor is 13 dB.

### Comparative Example 2

Molded Object of Polyvinylbutyral and PET “recycling” Fibers

95 vol. % PET “recycling” fibers and 5 vol. % polyvinylbutyral powder Mowital® (Polymer F) are intimately mixed.

The bottom and the cover of the mold, base area 30×30 cm, are lined with parting paper. Then the composition is evenly distributed thereon. This is pressed to a thickness of 9 mm at 190 C. for 20° minutes.

The molded object obtained has a density of 230 kg/m³ and a heat conductivity of 84 mW/mK. The tread acoustic improvement factor is 8 dB.

1. Multilayer composite material comprising at least one aerogel-containing layer and at least one layer containing polyethyleneterephthalate (PET) fibers.

2. Composite material according to claim 1, characterized by comprising at least three layers.

3. Composite material according to claim 1 or 2, characterized by comprising a sandwich structure in which one aerogel-containing layer is arranged between two layers each containing PET fibers.

4. Composite material according to at least one of the preceding claims, characterized in that the proportion of aerogel particles in the at least one aerogel-containing layer lies in the range from 5 to 97 vol. %.

5. Composite material according to at least one of the preceding claims, characterized in that the size of the aerogel particles lies in the range from 250 microns to 10 mm.

6. Composite material according to at least one of the preceding claims, characterized in that the aerogel particles used are such as contain Si compounds, preferably SiO₂ aerogels

7. Composite material according to at least one of the preceding claims, characterized in that the composite material and/or the aerogel particles contain IR turbidity agents.

8. Composite material according to at least one of the preceding claims, characterized in that the aerogel particles comprise lastingly hydrophobe surface groups.

9. Composite material according to at least one of the preceding claims, characterized in that the aerogel particles show porosities above 60% and densities below 0.6 g/cm³.

10. Composite material according to at least one of the preceding claims, characterized in that at least one layer containing PET fibers additionally contains aerogel particles as well.

11. Composite material according to at least one of the preceding claims, characterized in that the at least one aerogel-containing layer and the at least one layer containing PET fibers additionally contain at least one binder.

12. Composite material according to claim 11, characterized in that the binders employed are dispersion adhesives or polyvinylbutyrals.

13. Composite material according to at least one of the preceding claims, characterized in that the at least one aerogel-containing layer contains up to 50 vol. % fillers.

14. Composite material according to at least one of the preceding claims, characterized in that the at least one aerogel-containing layer additionally contains PET fibers.

15. Composite material according to at least one of the preceding claims, characterized by having a heat conductivity of less than 100 mW/mK.

16. Use of a composite material according to at least one of claims 1 to 15 for thermal and/or acoustic insulation.
